(19) United States
(12) Patent Application Publication
(10) Pub. No.: US 2007/0200969 A1
(43) Pub. Date: Aug. 30, 2007

(54) LIQUID CRYSTAL DISPLAY DEVICE AND BACK LIGHT MODULE THEREFOF

(76) Inventors: Wei-Chen Hsu, Taoyuan County (TW); Chia-Jung Fan, Taoyuan County (TW); Yao-Tung Wang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,870

(22) Filed: Feb. 26, 2006

(51) Int. Cl. G02F 1/1333

(52) U.S. Cl. 349/58

(57) ABSTRACT

A liquid crystal display (LCD) device includes a back light module, a LCD panel and a front frame. The back light module includes a metal back plate, a light-guiding plate, a reflection cover, a light source and a rubber frame. The light-guiding plate and the reflection cover are disposed inside the metal back plate, and the light-guiding plate has a light incident surface, a light emission surface and a side surface connected to the light emission surface. The reflection cover is located beside the light incident surface, and the light source is disposed therein. The rubber frame is disposed on the metal back plate and includes a body and a light-shielding portion connected thereof. The light-shielding portion is disposed between the side surface and the metal back plate. The front frame and the metal back plate are assembled together and together with the rubber frame, clamp the LCD panel.

### BACKGROUND OF THE INVENTION

1. Field of the Invention

The present invention relates to a display device. More particularly, the present invention relates to a liquid crystal display that can minimize the leakage of light.

2. Description of the Related Art

Following the rapid progress in video broadcasting and communication technology, liquid crystal display devices have been used as a display screen in many types of consumer produces including the mobile phones, the notebook computers, the personal computers and the personal digital assistants. Furthermore, with the advantages of light weight, small volume, low working voltage, low power consumption and low level of radiation, liquid crystal display devices have gradually become the mainstream display products.

FIG. 1 is a schematic cross-sectional view of a conventional liquid crystal display device. As shown in FIG. 1, the conventional liquid crystal display device 10 comprises a back light module 100, a liquid crystal display panel 102 and a front frame 104. The front frame 104 and a metal back plate 110 of the back light module 100 are assembled together, and with a rubber frame 120, clamp the liquid crystal display panel. The back light module 100 further includes a light-guiding plate 130, a light source (not shown) and a reflection cover (not shown). The light-guiding plate 130 is disposed inside the metal back plate 110. Furthermore, the metal back plate 110 has a stopper portion 112 for fixing the light-guiding plate 130. In addition, the light from a light source is reflected through the reflection cover into the light-guiding plate 130. The reflected light emitted from a light emission surface 132 of the light-guiding plate 130 to form a planar light source. Then, the light from the aforesaid planar light source passes through the liquid crystal display panel 102 to form an image.

Although most of the light from the light source is emitted from the light emission surface 132 of the light-guiding plate 130, a small portion of the light L emits from a side surface 134 of the light-guiding plate 130. Since the metal back plate 110 and the stopper portion 112 are both made of metallic material, they have a relatively high reflectivity. Hence, light L can easily be dispersed by reflection from the surface of the metal back plate 110 or the stopper portion 112 and channeled externally as leakage. In other words, a band of brighter area will surround the image displayed on the liquid crystal display device 10. Ultimately, the display quality will be adversely affected.

### SUMMARY OF THE INVENTION

Accordingly, at least one objective of the present invention is to provide a liquid crystal display device capable of minimizing the leakage of light.

At least another objective of the present invention is to provide a liquid crystal display device having a better image display quality.

To achieve these and other advantages and in accordance with the purpose of the invention, as embodied and broadly described herein, the invention provides a liquid crystal display device. The liquid crystal display device comprises a back light module, a liquid crystal display panel and a front frame. The back light module further includes a metal back plate, a light-guiding plate, a reflection cover, a light source and a rubber frame. The light-guiding plate is disposed inside the metal back plate and has a light incident surface, a light emission surface and a side surface. The side surface is connected to the light emission surface. The reflection cover is disposed inside the metal back plate and located beside the light incident surface of the light-guiding plate. The light source is disposed inside the reflection cover. The rubber frame is disposed on the metal back plate and includes a body and a light-shielding portion. The light-shielding portion is connected to the body and disposed between the side surface of the light-guiding plate and the metal back plate. The liquid crystal display panel is disposed on the rubber frame of the back light module. The front frame and the metal back plate of the back light module are assembled together and together with the rubber frame, clamp the liquid crystal display panel.

In one embodiment of the present invention, the light-guiding plate can have a notch on the side surface and the metal back plate can have a stopper portion suitable for lodging into the notch. Furthermore, the light-shielding portion is located between the notch and the stopper portion.

In one embodiment of the present invention, the side surface and the light incident surface are connected to each other.

In one embodiment of the present invention, the side surface and the light incident surface are located on the two respective sides of the light-guiding plate.

In one embodiment of the present invention, the body and the light-shielding portion can be formed together as a single unit.

In one embodiment of the present invention, the body and the light-shielding portion can be separately fabricated using different materials.

In one embodiment of the present invention, the light-shielding portion is fabricated using plastics, polyethylene terephthalate (PET), silicon, or PORON.

In one embodiment of the present invention, the back light module further includes at least an optical film disposed between the light-guiding plate and the rubber frame.

The present invention also provides an alternative liquid crystal display device comprising a back light module, a liquid crystal display panel and a front frame. The back light module further includes a metal back plate, a light-guiding plate, a reflection cover, a light source, a rubber frame and a light-shielding tape. The light-guiding plate is disposed inside the metal back plate and has a light incident surface, a light emission surface and a side surface. The side surface is connected to the light emission surface. The reflection cover is disposed inside the metal back plate and located beside the light incident surface of the light-guiding plate. The light source is disposed inside the reflection cover. The rubber frame is disposed on the metal back plate. The light-shielding tape is disposed on the side surface of the light-guiding plate or the metal back plate facing the side surface. The liquid crystal display panel is disposed on the rubber frame of the back light module. The front frame and the metal back plate of the back light module are assembled together and together with the rubber frame, clamp the liquid crystal display panel.

In one embodiment of the present invention, the light-guiding plate can have a notch disposed on the side surface and the metal back plate can have a stopper portion suitable for lodging into the notch. Furthermore, the light-shielding tape is disposed on the inner wall of the notch or on the stopper portion.

In one embodiment of the present invention, the side surface and the incident light surface are connected to each other.

In one embodiment of the present invention, the side surface and the light incident surface can be disposed on the respective sides of the light-guiding plate.

In one embodiment of the present invention, the light-shielding tape can be fabricated using black polyethylene terephthalate (PET), black silicon or black PORON.

In one embodiment of the present invention, the back light module further comprises at least an optical film disposed between the light-guiding plate and the rubber frame.

In brief, the liquid crystal display device in the present invention utilizes the light-shielding portion on the rubber frame between the side surface of the light-guiding plate and the metal back plate to block the light coming from the side surface of the light-guiding plate. Hence, the light-shielding portion prevents any light from dispersing externally after reflected from the surface of the metal back plate. As a result, the leakage of light from the periphery of the liquid crystal display device is minimized and the image display quality of the device is improved. In addition, the same reduced leakage of light from the periphery of the liquid crystal display device can be achieved by disposing a light-shielding tape on the side surface of the light-guiding plate or on the metal back plate facing the side surface.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic cross-sectional view of a conventional liquid crystal display device.

FIG. 2 is a perspective view showing the dissociated components in a localized portion of a back light module of a liquid crystal display device according to one embodiment of the present invention.

FIGS. 3A and 3B are diagrams showing different cross-sections of a liquid crystal display device according to one embodiment of the present invention.

FIGS. 4A and 4B are diagrams showing different cross-sections of a liquid crystal display device according to another embodiment of the present invention.

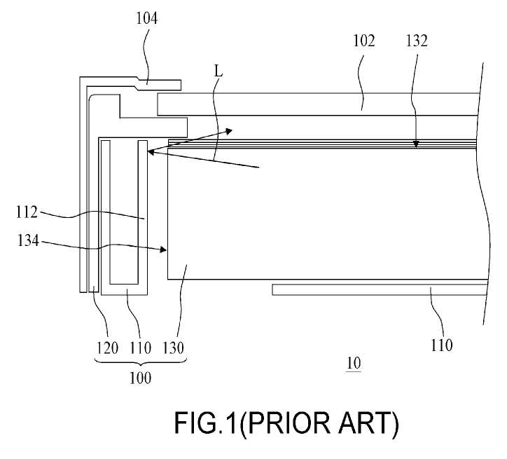

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

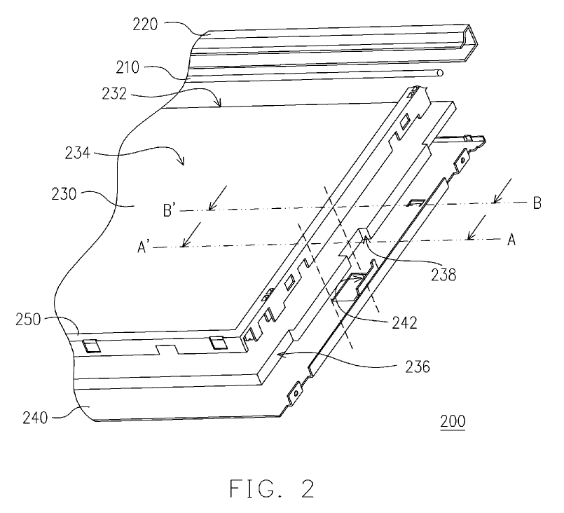

FIG. 2 is a perspective view showing the dissociated components in a localized portion of a back light module of a liquid crystal display device according to one embodiment of the present invention. As shown in FIG. 2, the back light module 200 in the present invention mainly comprises a light source 210, a reflection cover 220, a light-guiding plate 230, a metal back plate 240 and a rubber frame 250. The light source 210 is disposed inside the reflection cover 220 for emitting light. In the present embodiment, the light source 210 can be a point light source or a linear light source. The linear light source can be a cold cathode fluorescence lamp (CCFL) and the point light source can be a light emitting diode. The light-guiding plate 230 has at least a light incident surface 232, a light emission surface 234 and a side surface 236. The reflection cover 220 is disposed beside the light incident surface of the light-guiding plate 230 for reflecting the light emitted from the light source 210 into the light-guiding plate 230 through the light incident surface 232. In addition, the light incident surface 232 and the side surface 236 of the light-guiding plate 230 are connected to the respective light emission surface 234.

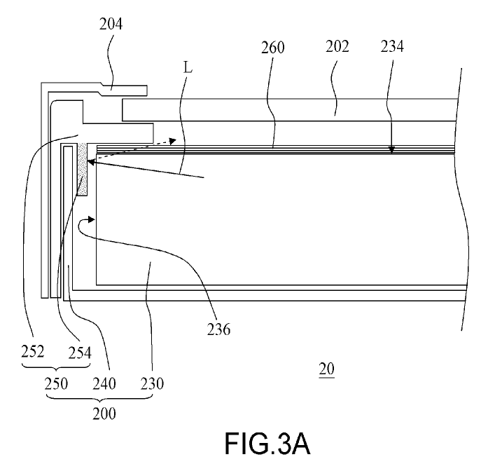

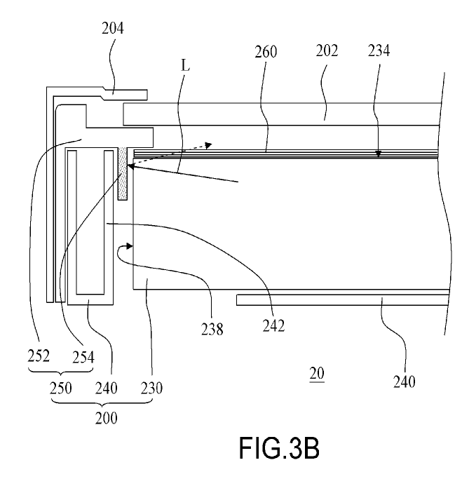

FIG. 3A is a diagram showing a cross-section of a liquid crystal display device according to one embodiment of the present invention, wherein the hatched line is the A-A′ line shown in FIG. 2. As shown in FIG. 3A, the liquid crystal display device 20 of the present invention includes, aside from the aforesaid back light module 200 (shown in FIG. 2), a liquid crystal display panel 202 and a front frame 204. The liquid crystal display panel 202 is disposed on the rubber frame 250 of the back light module 200. Furthermore, the front frame is suitable for assembling with the metal back plate 240 of the back light module 200. The front frame 204 and the rubber frame 250 of the back light module 200 together are adapted to clamping the liquid crystal display panel 202. The light-guiding plate 230 is disposed inside the metal back plate 240. Moreover, the rubber frame 250 is disposed on the metal back plate 240. The rubber frame 250 further includes a body 252 and a light-shielding portion 254. The light-shielding portion 254 and the body 252 are connected to each other and disposed between the side surface 236 of the light-guiding plate 230 and the metal back plate 240.

After the light from the light source 210 is channeled into the light-guiding plate 230, most of the light emits from the light emission surface 234 of the light-guiding plate 230. However, a small portion of the light L emits from the side surface 236 of the light-guiding plate 230. Due to the setup of a light-shielding portion 254 between the side surface 236 of the light-guiding plate 230 and the metal back plate 240, the light L emerging from the side surface 236 can hardly be reflected by the metal back plate 240 to cause light leakage. Furthermore, the light-shielding portion 254 is fabricated using high light-absorbing or low light reflecting material including plastics, polyethylene terephthalate (PET), silicon, or PORON, for example. In addition, the light-shielding portion 254 and the body 252 can be fabricated together as a single unit. The process of fabricating the integrative unit includes performing an injection molding process or performing some other suitable processes, for example. Obviously, the present invention is not limited to an integrative light-shielding portion 254 and the body 252 structure. For example, the light-shielding portion 254 and the body 252 can be separately formed and then the light-shielding portion 254 is thermally pressure bonded to the body 252 to form the rubber frame 250.

As shown in FIGS. 2 and 3A, the light-shielding portion 254 is disposed between the metal back plate 240 and the side surface 236 of the light-guiding plate 230 in the present embodiment. The side surface 236 and the light incident surface 232 are connected together. In other embodiment, the light-shielding portion 254 can also be disposed between the metal back plate 240 and the side surface facing the light incident surface 232 or between the metal back plate 240 and the side surface facing the side surface 236. Obviously, the present invention can dispose a light-shielding portion 254 in a number of the aforesaid locations simultaneously to improve the light-shielding effect. In addition, the back light module 200 in the present embodiment is a single-sided light incident back light module. Obviously, the back light module can easily be converted into a double-sided back light module with minor modifications. Under this scheme, the light-guiding plate 230 can have two opposing light incident surfaces 232 and two opposing side surfaces 236. In the present invention, the light-shielding portion 254 can be disposed between the two opposing side surfaces 236 and the metal back plate 240. In fact, anyone familiar with the technology may deduce the aforesaid conditions. Hence, a detailed description is omitted.

FIG. 3B is a different local cross-sectional view of the liquid crystal display device shown in FIG. 3A, wherein the hatched line is the A-A′ line shown in FIG. 2. As shown in FIG. 2 and FIG. 3B, the light-guiding plate 230 may further include a notch 238 on the side surface 236 to prevent any shakes of the light-guiding plate 230 inside the metal back plate 240. Furthermore, the metal back plate 240 has a stopper portion 242 that corresponds to the notch 238. The stopper portion 242 is flushed into the notch 238. Hence, the light-guiding plate 230 is fixed inside the metal back plate 240 and the light source 210 is prevented from receiving damage due to the impact. In the embodiment, the light-shielding portion 254 is located between the notch 238 and the stopper portion 242. Hence, the stopper portion 242 can hardly reflect the light L emitting from the notch 238 to cause significant light leakage.

FIG. 3A and FIG. 3B are different local cross-sectional view of the liquid crystal display device according to one embodiment of the present invention. As shown in FIGS. 3A and 3B, the light-shielding portion 254 is disposed between the periphery of the light-guiding plate 230 and the metal back plate 240. For example, the light-shielding portion 250 is disposed between the side surface 236 of the light-guiding plate 230 and the metal back plate 240 or between the notch 238 of the light-guiding plate 230 and the stopper potion 242 of the metal back plate 240. Thus, the light-shielding portion 236 can block the light emitting from the side surface 236 of the light-guiding plate 230 (and the notch 238 as well) and prevent light from reflecting from the metal back plate 242 (and the stopper portion 242) and leaking externally. Therefore, the present invention can reduce the leakage of light from the periphery of the liquid crystal display device 20 and improve the display quality.

In addition, the display quality of the liquid crystal display device 20 can be further improved through disposing an optical film 260 between the light-guiding plate 230 and the rubber frame 250. This optical film 260 can be a film plate such as a diffusion plate, a brightness enhancing plate, a prism lens so that the planar light source provided by the back light module 200 has more uniform distribution and greater brightness.

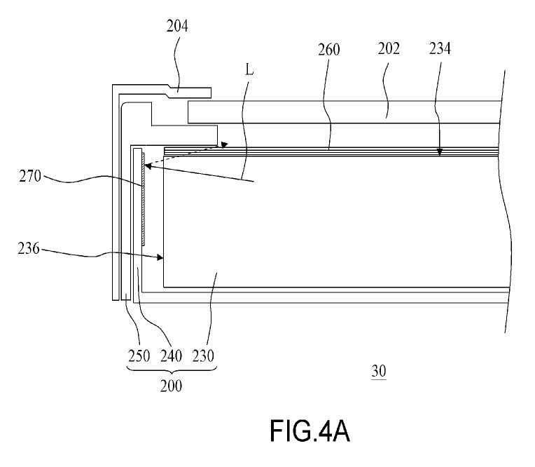

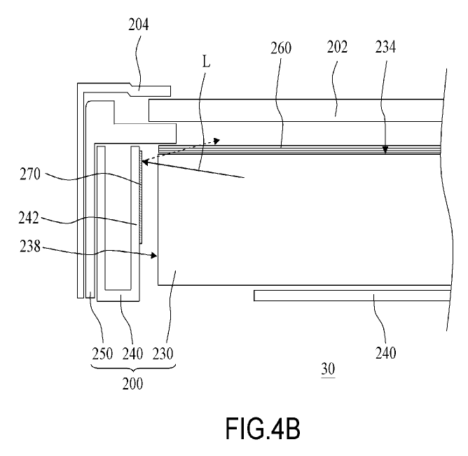

FIGS. 4A and 4B are diagrams showing different cross-sections of a liquid crystal display device according to another embodiment of the present invention. As shown in FIGS. 4A and 4B, the liquid crystal display device 30 in the present embodiment is very similar to the liquid crystal display device 20 in the previous embodiment (as shown in FIGS. 3A and 3B). The main difference is that the present embodiment includes attaching a light-shielding tape 270 instead of disposing the light-shielding portion 254 (shown in FIGS. 3A and 3B). In the present embodiment, the light-shielding tape 270 is attached to the side surface 236 of the metal back plate 240 (see FIG. 4A) facing the light-guiding plate 230 or attached to the stopper portion 242 (see FIG. 4B) facing the notch 238 of the light-guiding plate 230. Hence, the light L emitting from the side 236 of the light-guiding plate 230 will be blocked by the light-shielding tape 270 instead of dispersing externally, leading to light leakage from the liquid crystal display device 30.

Obviously, in other embodiment, the light-shielding tape 270 can be directly attached to the side surface 236 of the light-guiding plate 230 or the inner wall of the notch 238 in the light-guiding plate 230 to achieve the same effect. In addition, there is no particular limitation to the position for attaching the light-shielding tape 270. For example, the light-shielding tape 270 can be simultaneously attached to the aforementioned positions (including the metal back plate 240, the stopper portion 242, the side surface 236, the notch 238) to attain the best shielding effect. Furthermore, the light-shielding tape 270 can be fabricated using black polyethylene terephthalate (PET), black silicon or black PORON or some other suitable material, for example.

It should be noted that the liquid crystal display device in the present invention is not limited to the disposition of either the light-shielding portion or the light-shielding tape. To improve the display quality of the liquid crystal display device, the present invention also allows the disposition of the light-shielding portion and the light-shielding tape to achieve a better effect.

In summary, the advantage of the liquid crystal display device in the prevent invention at least includes the following:

1. By setting up a light-shielding portion on the rubber frame and disposing the light-shielding portion between the side surface of the light-guiding plate and the metal back plate, the light emitting from the side surface of the light-guiding plate is blocked to prevent the light from dispersing externally after a reflection by the metal back plate.

2. By disposing a light-shielding tape on the side surface of the light-guiding plate or the side surface of the metal back plate, the leakage of light from the periphery of the liquid crystal display device is minimized and the display quality is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display device, comprising:
a back light module, having:
a back metal plate;
a light-guiding plate disposed inside the metal back plate, wherein the metal back plate has an incident surface, an emission surface and a side surface such that the side surface and the light incident surface are connected to each other;
a reflection cover disposed inside the metal back plate and located beside the light incident surface of the light-guiding plate;
a light source disposed inside the reflection cover;
a rubber frame disposed on the metal back plate, wherein the rubber frame further comprises a body and a light-shielding portion, the light-shielding portion and the body being connected to each other and the light-shielding portion being disposed between the side surface of the light-guiding plate and the metal back plate;
a liquid crystal display panel disposed on the rubber frame of the back light module; and
a front frame assembled to the metal back plate of the back light module such that the front frame and the rubber frame together clamp the liquid crystal display panel.

2. The liquid crystal display device of claim 1, wherein the light-guiding plate has a notch located on the side surface and the metal back plate has a stopper portion flushing into the notch, and the light-shielding portion is located between the notch and the stopper portion.

3. The liquid crystal display device of claim 1, wherein the side surface and the light incident surface are connected to each other.

4. The liquid crystal display device of claim 1, wherein the side surface and the light incident surface are disposed on the respective sides of the light-guiding plate.

5. The liquid crystal display device of claim 1, wherein the body and the light-shielding body are formed together as a single unit.

6. The liquid crystal display device of claim 1, wherein the body and the light-shielding portion are fabricated using different materials.

7. The liquid crystal display device of claim 1, wherein the material constituting the light-shielding portion includes plastics, PET, silicon or PORON.

8. The liquid crystal display device of claim 1, wherein the back light module further includes at least an optical film disposed between the light-guiding plate and the rubber frame.

9. A liquid crystal display device, comprising:
a back light module, having:
a back metal plate;
a light-guiding plate disposed inside the metal back plate, wherein the metal back plate has an incident surface, an emission surface and a side surface such that the side surface and the light incident surface are connected to each other;
a reflection cover disposed inside the metal back plate and located beside the light incident surface of the light-guiding plate;
a light source disposed inside the reflection cover;
a rubber frame disposed on the metal back plate;
a light-shielding tape disposed on the side surface of the light-guiding plate or the side surface of the metal back plate;
a liquid crystal display panel disposed on the rubber frame of the back light module; and
a front frame assembled to the metal back plate of the back light module such that the front frame and the rubber frame together clamp the liquid crystal display panel.

10. The liquid crystal display device of claim 9, wherein the light-guiding plate has a notch located on the side surface and the metal back plate has a stopper portion flushing into the notch, and the light-shielding tape is located on the inner wall of the notch or the on the stopper portion.

11. The liquid crystal display device of claim 9, wherein the side surface and the light incident surface are connected to each other.

12. The liquid crystal display device of claim 9, wherein the side surface and the light incident surface are disposed on the respective sides of the light-guiding plate.

13. The liquid crystal display device of claim 9, wherein the material constituting the light-shielding tape includes black PET, black silicon or black PORON.

14. The liquid crystal display device of claim 9, wherein the back light module further includes at least an optical film disposed between the light-guiding plate and the rubber frame.
